(19) United States
(12) Patent Application Publication
(10) Pub. No.: US 2025/0155412 A1
(43) Pub. Date: May 15, 2025

(54) ULTRASONIC TESTING DEVICE FOR RAIL BOTTOM AND TESTING METHOD USING THE SAME

(71) Applicant: SHANGHAI ORIENTAL MARITIME ENGINEERING TECHNOLOGY CO., LTD, Shanghai (CN)

(72) Inventors: Jian WAN, Shanghai (CN); Jianjun WANG, Shanghai (CN); Yongjun LI, Shanghai (CN); Tianle YU, Shanghai (CN); Jun KUANG, Shanghai (CN); Xipeng FENG, Shanghai (CN); Jianzhi GUO, Shanghai (CN)

(21) Appl. No.: 18/274,640

(22) PCT Filed: Mar. 9, 2022
(86) PCT No.: PCT/CN2022/079976

§ 371 Date: Nov. 18, 2024

(51) Int. Cl. G01N 29/26; G01N 29/34

(52) U.S. Cl. CPC G01N 29/262; G01N 29/343; G01N 2291/106; G01N 2291/2623; G01N 2291/2675

(57) ABSTRACT

The invention discloses an ultrasonic testing device for rail bottom and a testing method using the same. Top surfaces of both sides of the rail bottom include at least one working surface respectively, and the working surface is at least provided with one set of phased array probe assemblies. Each set of phased array probe assemblies includes two phased array probes distributed on both sides of a weld seam, and the phased array probe forms a contact area with the working surface and generates pulsed ultrasonic beams with different incident angles to enter the rail bottom for flaw testing. The phased array probe can be deflected relative to the rail bottom to realize full-coverage testing for the rail bottom.

### FIELD OF THE INVENTION

The invention belongs to the field of weld seam testing for the rail, in particular, to an ultrasonic testing device for rail bottom and a testing method using the same.

### DESCRIPTION OF THE PRIOR ART

Although rail testing has become a mature commercial technology, weld seam testing still has huge room for optimization. Ultrasonic testing for existing railways is carried out with testing vehicles. The rolling search unit of the testing vehicle adopts multiple single crystal probes, and the flaws in the rail head and the rail waist can be completely covered. However, only flaws in the rail head and the rail waist can be detected, while flaws in the rail bottom cannot be detected.

In the weld seam testing for the rail, the testing for the rail bottom is essential as many rail failures originate from the bottom of the weld seam. Under current inspection standards, full coverage testing for the rail bottom is usually performed manually, which is a method of operation that relies heavily on the operator and is subject to many human errors. In addition, the efficiency of manual operation is quite low, which cannot meet the current requirements for high detection frequency proposed by most countries.

### SUMMARY OF THE INVENTION

An objective of the invention is to provide an ultrasonic testing device for rail bottom and a testing method using the same, so as to realize the full-coverage testing for the rail bottom automatically.

In order to solve the above problems, the invention uses the following technical solutions:

An ultrasonic testing device for rail bottom, top surfaces of both sides of the rail bottom including at least one working surface respectively, wherein the working surface is at least provided with one set of phased array probe assemblies; each set of phased array probe assemblies includes two phased array probes distributed on both sides of a weld seam, and the phased array probe forms a contact area with the working surface and generates pulsed ultrasonic beams with different incident angles to enter the rail bottom for flaw testing; the phased array probe can be deflected relative to the rail bottom to realize full-coverage testing for the rail bottom.

Preferably, the top surfaces on both sides of the tail bottom include two working surfaces, which are respectively a first working surface and a second working surface arranged side by side horizontally, and the transition between the first working surface and the second working surface is through an arc surface;
both the first working surface and the second working surface are at least provided with one set of phased array probe assemblies.

Preferably, the phased array probe is deflected to a rail center or away from the rail center relative to the rail bottom, and a deflection angle is from −30° to +30°.

Preferably, the incident angle formed by the phased array probe in the rail is from 45° to 75°.

An ultrasonic testing method for rail bottom, using the ultrasonic testing device for rail bottom mentioned above, wherein the method includes steps of:
S1, arranging at least one set of phased array probe assemblies on each of the working surfaces on the top surfaces of both sides of the rail bottom, respectively, wherein two phased array probes comprised in each set of phased array probe assemblies are distributed on both sides of the weld seam, and the phased array probe is caused to form a contact area with the working surface;
S2, emitting a number of pulsed ultrasonic beams with different incident angles by adjusting an excitation time of an array element combination of each of the phased array probes, introducing each of the pulsed ultrasonic beams into the rail bottom along its own beam axis for scanning, and obtaining scanning results;
S3, adjusting each of the phased array probes so that the phased array probe is deflected to the rail center or away from the rail center and the phased array probe emits the pulsed ultrasonic beam to scan a testing blind area that is not scanned in the step S2, and obtaining the scanning results;
S4, determining whether there is a flaw in the rail bottom at the weld seam and obtaining a specific shape and a location of the flaw according to the scanning results in the step S2 and the step S3. Due to the above technical solutions, the invention has the following advantages and beneficial effects as compared to the prior art:

In the invention, multiple sets of phased array probes are used to scan the rail bottom to realize flaw testing, and using the sector scanning technology of the phased array probe may cover the testing area without manual movement of the probe. At the same time, the flaws in the actual weld seam have an uncertain development trend; while in the invention, the phased array probes are arranged on both sides of the weld seam on the inner and outer sides of the rail to detect from both sides of the weld seam, which is conducive to better testing of flaws in different directions. Moreover, the phased array probes on each of the working surfaces will have scanning blind spots when scanning and testing; while in the invention, through the provision of the phased array probe that may be deflected relative to the rail bottom, the full-coverage testing for the rail bottom may be realized just by rotating the phased array probe.

### BRIEF DESCRIPTION OF THE DRAWINGS

FIG. 1 is a schematic diagram of beam deflection of a phased array probe;

FIG. 2 is a schematic diagram of an incident beam of a single phased array probe;

FIGS. 3a to 3f are schematic diagrams of simulation of testing the flaws of the horizontal through hole at the rail bottom by the phased array probe;

FIG. 4 is a schematic structural diagram of a rail bottom in Embodiment One;

FIG. 5 is a schematic diagram of arranging the phased array probe in the horizontal direction in Embodiment One;

FIG. 6 is a schematic diagram of arranging the phased array probe in the longitudinal direction in Embodiment One;

FIG. 7 is a cross-sectional schematic diagram when a first working surface is provided with one set of phased array probe assemblies and a second working surface is provided with two sets of phased array probe assemblies;

FIG. 8 is a cross-sectional schematic diagram when the first working surface is provided with two sets of phased array probe assemblies and the second working surface is provided with two sets of phased array probe assemblies;

FIG. 9 is a propagation path of the ultrasonic sound beam of the phased array probe in the longitudinal direction of the rail;

FIG. 10 is a propagation path of the ultrasonic sound beam of the phased array probe in the horizontal direction of the rail;

FIG. 11 is a three-dimensional schematic diagram of the phased array probe on the first working surface when being deflected to the center of the rail;

FIG. 12 is a cross-sectional schematic diagram of the phased array probe on the first working surface when being deflected to the center of the rail;

FIG. 13 is a three-dimensional schematic diagram of the phased array probe on the first working surface when being deflected away from the center of the rail;

FIG. 14 is a cross-sectional schematic diagram of the phased array probe on the first working surface when being deflected away from the center of the rail;

FIG. 15 is a three-dimensional schematic diagram of the phased array probe on the second working surface when being deflected to the center of the rail;

FIG. 16 is a cross-sectional schematic diagram of the phased array probe on the second working surface when being deflected to the center of the rail;

FIG. 17 is a three-dimensional schematic diagram of the phased array probe on the second working surface when being deflected away from the center of the rail;

FIG. 18 is a cross-sectional schematic diagram of the phased array probe on the second working surface when being deflected away from the center of the rail;

FIG. 19 is a schematic diagram of a single probe deflecting under force at a single position;

FIG. 20 is a schematic diagram of a single probe deflecting under force at a relative position;

FIG. 21 is a schematic diagram of multiple probes deflecting in opposite directions under force from the same position;

FIG. 22 is a schematic diagram of multiple probes deflecting in the same direction under force from the same position;

FIG. 23 is a schematic diagram of multiple probes deflecting in opposite directions under force from the relative position;

FIG. 24 is a schematic diagram of multiple probes deflecting in the same direction under force from the relative position.

### DESCRIPTION OF REFERENCE NUMERALS

1: rail; 11: rail bottom; 111: first working surface; 112: arc surface; 113: second working surface; 2: phased array probe; 3: drive device.

### DESCRIPTION OF THE PREFERRED EMBODIMENTS

The invention will be described in more detail hereinafter with reference to the accompanying drawings showing embodiments of the invention. However, the invention may be embodied in many different forms and should not be construed as limited to the embodiments set forth herein. Instead, these embodiments are provided so that the disclosure will be thorough and complete, and will fully convey the scope of the invention to those skilled in the art. In the drawings, the size and relative sizes of layers and regions may be exaggerated for clarity.

It should be noted that all directional indications (for example, upper, lower, left, right, front, rear and etc.) in the embodiments are merely used for explaining relative position relationships and moving conditions and etc among parts in a certain special gesture (as shown in the drawings). The directional indications change as well therewith when the special gesture changes.

An ultrasonic testing device for rail bottom and a testing method using the same proposed by the invention will be further described in detail below in conjunction with the accompanying drawings and specific embodiments. Advantages and features of the invention will be apparent from the following description and claims.

### Embodiment One

The embodiment provides an ultrasonic testing device for rail bottom, top surfaces of both sides of the rail bottom including at least one working surface respectively, wherein the working surface is at least provided with one set of phased array probe assemblies; each set of phased array probe assemblies includes two phased array probes distributed on both sides of a weld seam, and the phased array probe forms a contact area with the working surface and generates pulsed ultrasonic beams with different incident angles to enter the rail bottom for flaw testing; the phased array probe can be deflected relative to the rail bottom to realize full-coverage testing for the rail bottom.

In the invention, multiple sets of phased array probes are used to scan the rail bottom to realize flaw testing, and using the sector scanning technology of the phased array probe may cover the testing area without manual movement of the probe. At the same time, the flaws in the actual weld seam have an uncertain development trend; while in the invention, the phased array probes are arranged on both sides of the weld seam on the inner and outer sides of the rail to detect from both sides of the weld seam, which is conducive to better testing of flaws in different directions. Moreover, the phased array probes on each of the working surfaces will have scanning blind spots when scanning and testing; while in the invention, through the provision of the phased array probe that may be deflected relative to the rail bottom, the full-coverage testing for the rail bottom may be realized just by rotating the phased array probe.

The principle of ultrasonic phased array testing technology is as follows: many small piezoelectric chips are used to generate and receive ultrasonic beams, the phase of the excitation pulse of each chip in the piezoelectric chip array is controlled by electronic methods and powerful software, and the ultrasonic fields generated by the plurality of piezoelectric chips in the testing object are mutually interfered and superimposed, so as to obtain an incident angle and a focus position of pre-desired synthesized beams. With electronic technology, controlled by software, each unit of an array probe can be excited successively at different times to focus and control the ultrasonic wavefront to a specific direction so that the ultrasonic beam emitted by the probe fixed at one position dynamically scans a selected beam angle range in the tested workpiece, i.e., sectoral scanning. The invention utilizes the phased array sector scanning technology and can realize the coverage of the testing area without manual displacement of the probe.

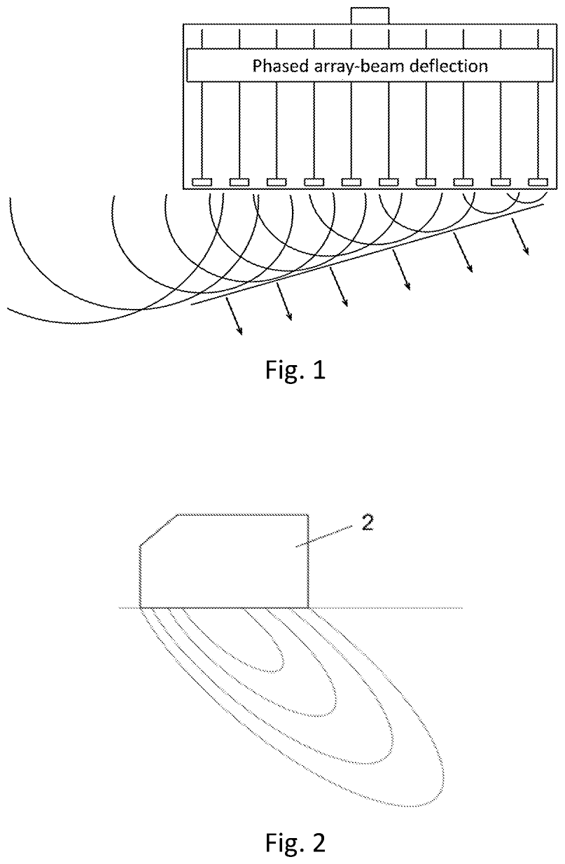

FIG. 1 is a schematic diagram of beam deflection of a phased array probe; FIG. 2 is a schematic diagram of an incident beam of a single phased array probe. The piezoelectric chip is electronically controlled to trigger the phased array probe in a time-sharing manner, so different incident angles can be formed. In the embodiment, the testing is mainly performed with an incident angle from 45° to 75°. Needless to say, in other embodiments, the incident angle can also be adjusted according to specific needs, which is not limited here.

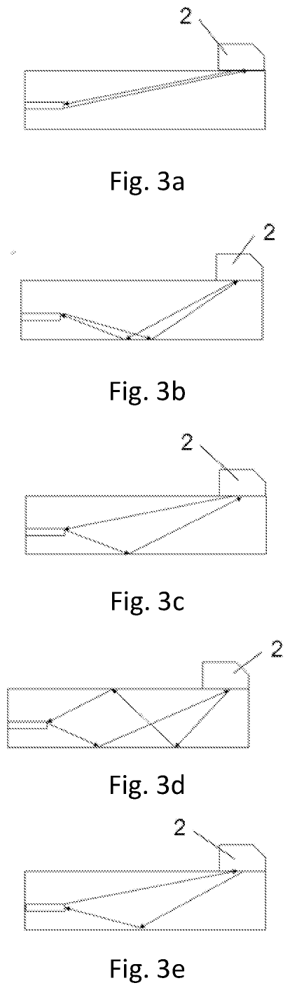

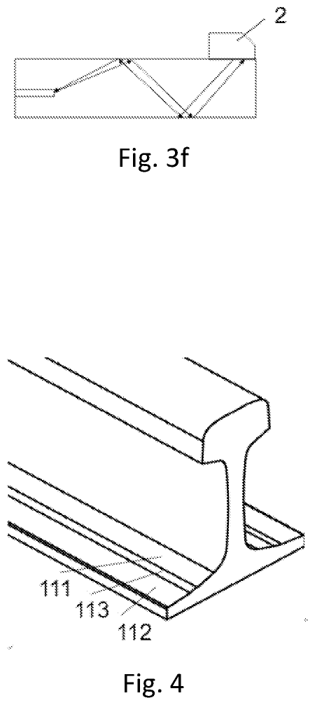

FIGS. 3a to 3f are schematic diagrams of simulation of testing the flaws of the horizontal through hole at the rail bottom by the phased array probe. It can be seen from the figures that when the phased array probe forms ultrasonic incident sound beams at different angles, the sound beams at multiple angles can test flaws of the standard transverse through hole, which is easier to test flaws than the conventional probe with a single sound beam.

In the embodiment, as shown in FIG. 4, the top surfaces on both sides of the tail bottom include two working surfaces, which are respectively a first working surface 111 and a second working surface 113, and the transition between the first working surface 111 and the second working surface 113 is through an arc surface 112. The first working surface 111 and the second working surface 113 are arranged side by side horizontally (i.e., perpendicular to the traveling direction of the train), and both the first working surface 111 and the second working surface 113 extend longitudinally (i.e., along the traveling direction of the train). Needless to say, in other embodiments, the number and specific form of the working surfaces on the top surface of the rail bottom can be adjusted according to specific conditions, and there is no limitation here.

Next, the layout of each phased array probe is carried out based on the schematic structural diagram of the rail bottom shown in FIG. 4.

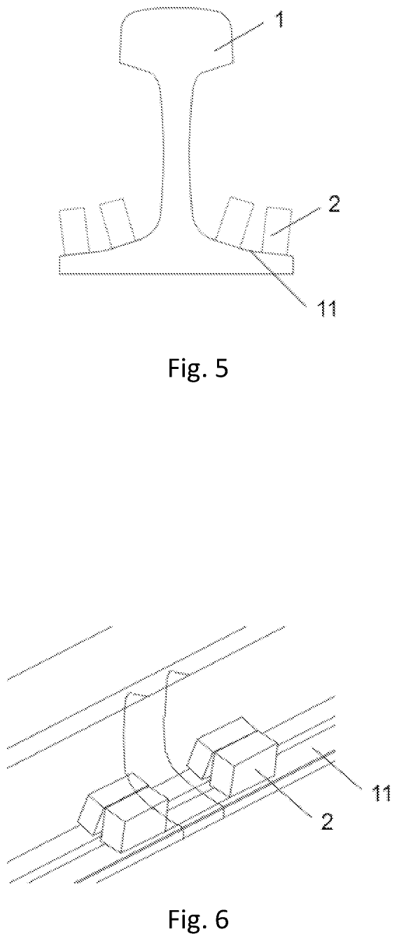

Specifically, in the embodiment, at the center of the rail and at a side away from the center of the rail, the first working surface 111 and the second working surface 113 on the rail bottom 11 are both provided with one set of phased array probe assemblies. As shown in FIG. 5, each set of the phased array probe assemblies includes two phased array probes 2, and the two phased array probes 2 are distributed on both sides of the weld seam. As shown in FIG. 6, eight phased array probes 2 are simultaneously arranged on the upper surface of the entire rail bottom, and each of the phased array probes 2 emits a pulsed ultrasonic beam toward the weld seam. The flaws in actual weld seam have an uncertain development trend. In the invention, the phased array probes are arranged on both sides of the weld seam on the inner and outer sides of the rail, and the testing is performed from both sides of the weld seam, which is beneficial to better testing of flaws in different directions.

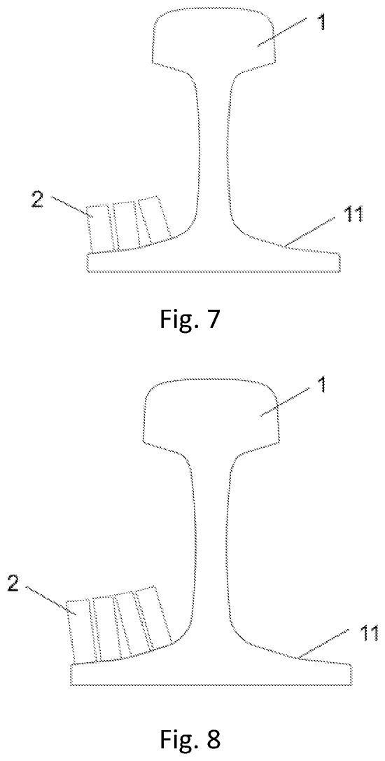

Needless to say, in other embodiments, one set of phased array probe assemblies may also be arranged on the first working surface 111, and two sets of phased array probe assemblies may also be arranged on the second working surface 113, as shown in FIG. 7; or, two sets of phased array probe assemblies can be arranged on the first working surface 111, and two sets of phased array probe assemblies can be arranged on the second working surface 113, as shown in FIG. 8. The number of phased array probe assemblies mounted on each of the working surfaces can be adjusted and selected according to factors such as the size of the working surface, and there is no limitation here.

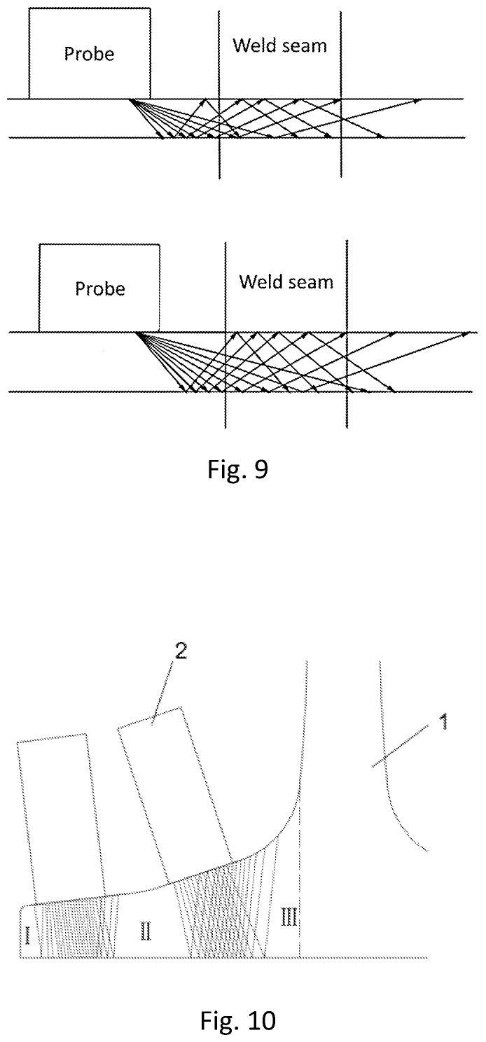

Further, with reference to FIG. 9, the propagation paths of ultrasonic sound beams emitted by phased array probes located on the first working surface 111 and on the second working surface 113 in the longitudinal direction of the rail (parallel to the traveling direction of the train) are respectively shown. From the figures, it is obvious that the ultrasonic beams of the phased array probes cover the weld seam area.

Further, with reference to FIG. 10, the propagation paths of ultrasonic beams of each phased array probe in the horizontal direction of the rail are respectively shown. In the initial situation, each phased array probe 2 is arranged parallel to the first working surface 111 and the second working surface 112. Then, it can be seen from FIG. 10 that the phased array probe 2 can achieve the testing coverage of most areas in the horizontal direction, but there are still some testing blind spots. The testing blind area mainly includes the edge part I of the rail bottom, the arc surface part II of the rail bottom, and the part III near the triangular area of the rail bottom;

In view of the problem of incomplete coverage of the rail bottom when the phased array probe is placed parallel to the rail in the initial situation above; in the invention, the phased array probe 2 is configured to be deflectable relative to the rail bottom, and the scanning range of the phased array probe 2 is adjusted by deflecting the phased array probe 2.

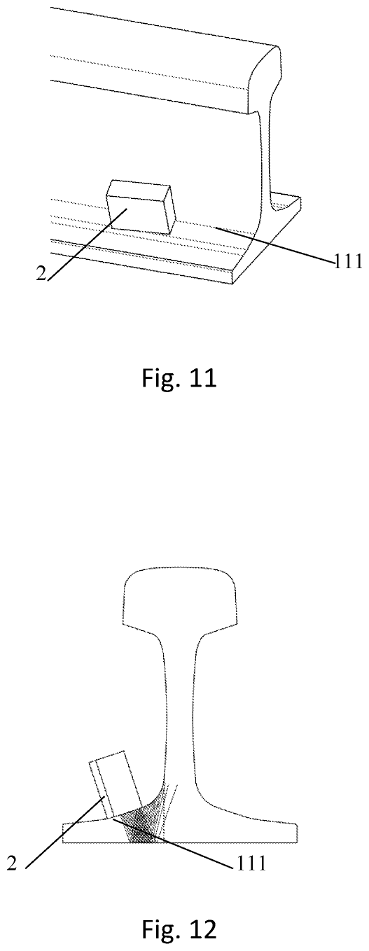

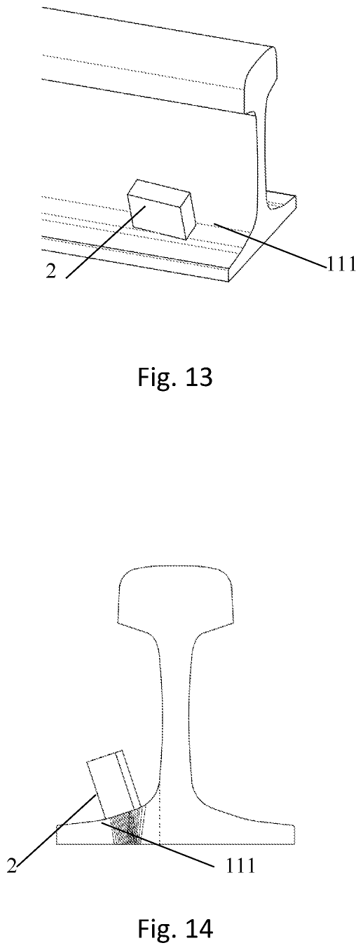

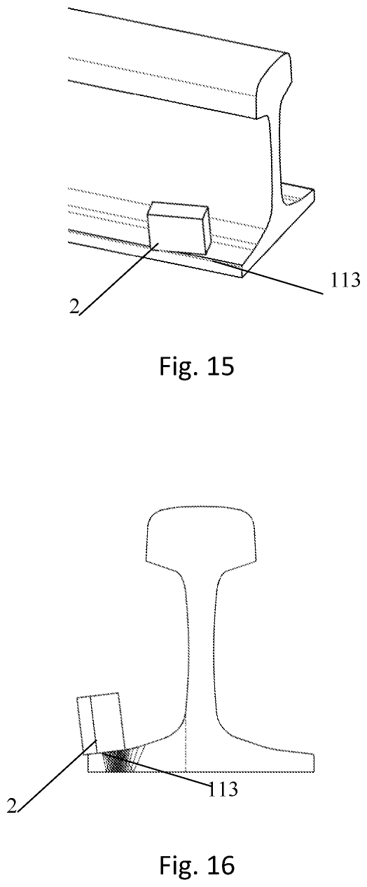

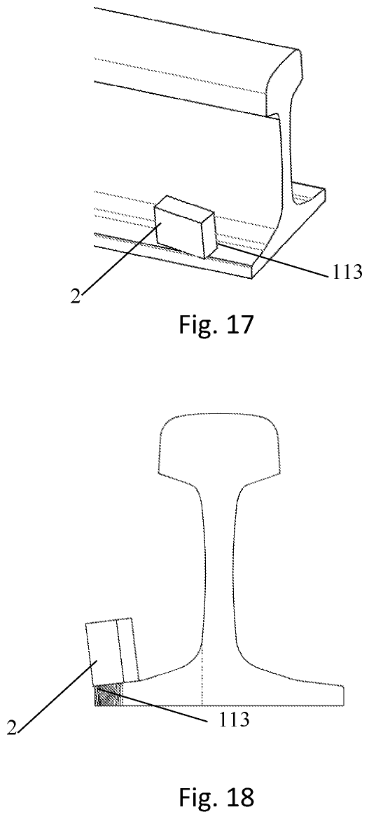

With reference to FIGS. 11 to 12, by deflecting the phased array probe 2 on the first working surface 111 toward the rail center, the effective coverage of the sound beam coverage blind spot III when the probe is placed in parallel for testing can be realized;
with reference to FIGS. 13 to 14, by deflecting the phased array probe 2 on the first working surface 111 away from the rail center, and with reference to FIGS. 15 to 16, by deflecting the phased array probe 2 on the second working surface 113 toward the rail center, the effective coverage of the sound beam coverage blind spot II when the probe is placed in parallel for testing can be realized;
with reference to FIGS. 17 to 18, by deflecting the phased array probe 2 on the second working surface 113 away from the rail center, the effective coverage of the sound beam coverage blind spot I when the probe is placed in parallel for testing can be realized.

It can be seen from the above that in the embodiment, one set of phased array probe assemblies are respectively arranged on the first working surface and the second working surface and is enabled to deflect in different directions, so that the full coverage testing for the rail bottom of the rail weld seam may be realized fully. Similarly, if two or more sets of phased array probe assemblies are used on the first working surface and the second working surface, it is also possible to fully cover the testing for the rail bottom when the probe is placed on the surface of the rail bottom and is enabled to deflect in different directions.

Further, in the embodiment, the initial positions of each phased array probe 2 are arranged parallel to the length direction of the rail. Needless to say, they may not be set parallel in other embodiments, and there is no limitation here.

In the embodiment, preferably, the phased array probe is deflected to a rail center or away from the rail center relative to the rail bottom, and a deflection angle is from −30° to +30°. Needless to say, in other embodiments, the deflection angle can be adjusted according to specific conditions, and there is no limitation here.

In the embodiment, the deflection mode of each phased array probe 2 can be specifically equipped with a drive device for the phased array probe 2, so as to realize the deflection of the phased array probe 2 toward the rail center or away from the rail center. There are many kinds of drive device, such as electric push rod, pneumatic push rod, hydraulic push rod, linear motion motor, linear motion cylinder, linear motion hydraulic cylinder and other mechanisms. There are many ways of transmission between the automation apparatus and the phased array probe 2, such as shaft transmission, connecting rod transmission, gear transmission, rack transmission, synchronous belt transmission, etc., which are not limited here and can be adjusted according to specific conditions.

Further, the drive device drives the phased array probe 2 in many ways, which are specifically as follows:

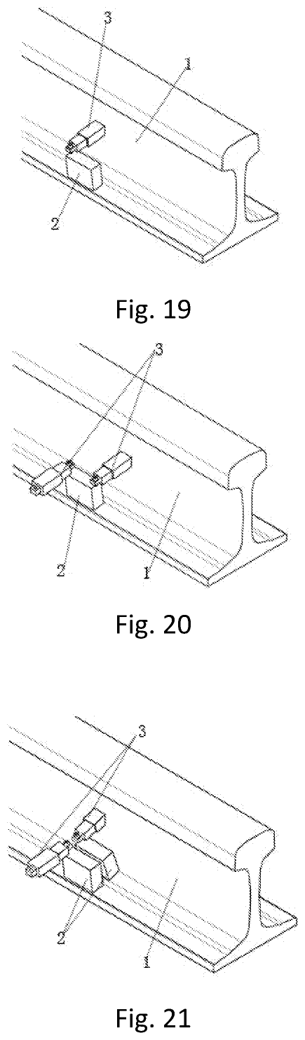

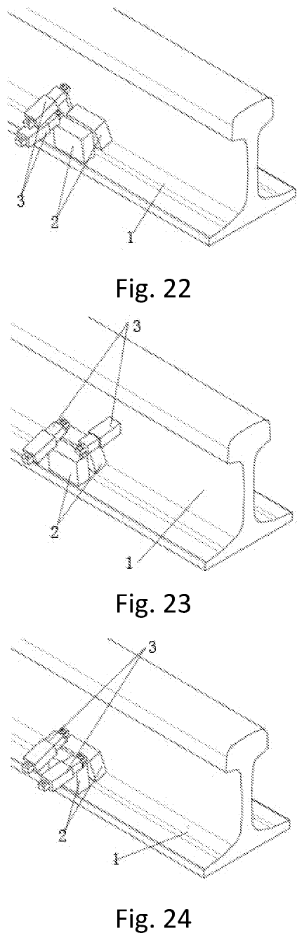

As shown in FIG. 19, a single phased array probe 2 may only be provided with a drive device 3 at one end, and then a single probe is deflected by force at a single position; as shown in FIG. 20, both ends of a single phased array probe 2 are provided with the drive devices 3, and then a single probe is deflected by force at two relative positions; as shown in FIG. 21, the same end of the two phased array probes 2 is respectively provided with the drive device 3, and the multiple probes are deflected from the same position to the opposite direction by force; as shown in FIG. 22, the same end of the two phased array probes 2 is respectively provided with the drive device 3, and the multiple probes are deflected from the same position to the same direction by force; as shown in FIG. 23, the different ends of the two phased array probes 2 are respectively provided with the drive device 3, and the multiple probes are deflected from relative positions to opposite directions by force; as shown in FIG. 24, the different ends of the two phased array probes 2 are respectively provided with the drive device 3, so that the multiple probes are deflected in the same direction from relative positions.

The way in which the above-mentioned drive device drives the phased array probe 2 can be selected according to specific conditions, and there is no limitation here.

### Embodiment Two

The embodiment provides an ultrasonic testing method for rail bottom, which uses the ultrasonic testing device for rail bottom mentioned in Embodiment One.

Specifically, the ultrasonic testing method for rail bottom includes the following steps:
S1, at least one set of phased array probe assemblies is arranged on each of the working surfaces on the top surfaces of both sides of the rail bottom respectively, wherein two phased array probes comprised in each set of phased array probe assemblies are distributed on both sides of the weld seam, and the phased array probe is caused to form a contact area with the working surface;
further, preferably, the phased array probe is arranged parallel to the first working surface and the second working surface.
S2, a number of pulsed ultrasonic beams with different incident angles are emitted by adjusting an excitation time of an array element combination of each of the phased array probes, each of the pulsed ultrasonic beams is introduced into the rail bottom along its own beam axis for scanning, and scanning results are obtained;
S3, each of the phased array probes is adjusted so that the phased array probe is deflected to the rail center or away from the rail center, and the phased array probe emits the pulsed ultrasonic beam to scan a testing blind area that is not scanned in the step S2, and the scanning results are obtained;
S4, whether there is a flaw in the rail bottom at the weld seam is determined and a specific shape and a location of the flaw are obtained according to the scanning results in the step S2 and the step S3.

The implementations of the present invention are described in detail above with reference to the accompanying drawings, but the present invention is not limited to the above implementations. Even if various changes are made to the present invention, if these changes fall within the scope of the claims of the present invention and equivalent technologies, they still fall within the protection scope of the present invention.

What is claimed is:

1. An ultrasonic testing device for rail bottom, top surfaces of both sides of the rail bottom comprising at least one working surface respectively, wherein:
the working surface is at least provided with one set of phased array probe assemblies;
each set of phased array probe assemblies comprises two phased array probes distributed on both sides of a weld seam, and the phased array probe forms a contact area with the working surface and generates pulsed ultrasonic beams with different incident angles to enter the rail bottom for flaw testing; and,
the phased array probe can be deflected relative to the rail bottom to realize full-coverage testing for the rail bottom.

2. The ultrasonic testing device for rail bottom according to claim 1, wherein the top surfaces on both sides of the tail bottom both comprise two working surfaces that are respectively a first working surface and a second working surface arranged side by side horizontally, and the transition between the first working surface and the second working surface is through an arc surface;
both the first working surface and the second working surface are at least provided with one set of the phased array probe assemblies.

3. The ultrasonic testing device for rail bottom according to claim 1, wherein the phased array probe is deflected to a rail center or away from the rail center relative to the rail bottom, and a deflection angle is from −30° to +30°.

4. The ultrasonic testing device for rail bottom according to claim 1, wherein the incident angle formed by the phased array probe in the rail is from 45° to 75°.

5. An ultrasonic testing method for rail bottom, using the ultrasonic testing device for rail bottom according to any one of claims 1 to 4, wherein the method comprises steps of:
S1, arranging at least one set of phased array probe assemblies on each of the working surfaces on the top surfaces of both sides of the rail bottom respectively, wherein two phased array probes comprised in each set of the phased array probe assemblies are distributed on both sides of the weld seam, and the phased array probe is caused to form a contact area with the working surface;
S2, emitting a number of pulsed ultrasonic beams with different incident angles by adjusting an excitation time of an array element combination of each of the phased array probes, introducing each of the pulsed ultrasonic beams into the rail bottom along its own beam axis for scanning, and obtaining scanning results;
S3, adjusting each of the phased array probes so that the phased array probe is deflected to the rail center or away from the rail center and the phased array probe emits the pulsed ultrasonic beam to scan a testing blind area that is not scanned in the step S2, and obtaining the scanning results;
S4, determining whether there is a flaw in the rail bottom at the weld seam and obtaining a specific shape and a location of the flaw according to the scanning results in the step S2 and the step S3.
